(19) United States
(12) Patent Application Publication
(10) Pub. No.: US 2019/0107615 A1
(43) Pub. Date: Apr. 11, 2019

(54) METHOD OF TRACKING AN OBJECT

(71) Applicant: GM Global Technology Operations LLC, Detroit, MI (US)

(72) Inventors: Ishai Eljarat, Raanana (IL); Gonen Barkan, Lehavim (IL); Igal Bilik, Rehovot (IL)

(73) Assignee: GM Global Technology Operations LLC, Detroit, MI (US)

(21) Appl. No.: 15/726,082

(22) Filed: Oct. 5, 2017

(51) Int. Cl. G01S 13/60; G01S 13/50; G01S 13/58

(52) U.S. Cl. CPC G01S 13/60; G01S 2007/4095; G01S 13/581; G01S 13/505

(57) ABSTRACT

A method of tracking an object includes establishing a track from a plurality of sequential Doppler radar frames f−1, f−2, f−3, etc. A location of a representative centroid of a cluster of data points is identified in a Doppler radar frame f. A radial velocity between a location of the track in the Doppler radar frame f−1 and the location of the representative centroid of the cluster in the Doppler radar frame f is calculated. An error between a Doppler velocity of the track in the Doppler radar frame f−1 and the calculated radial velocity is calculated. When the calculated error is less than a minimum error threshold, the representative centroid of the cluster in the Doppler radar frame f is associated with the track.

### INTRODUCTION

The disclosure generally relates to a method of clustering and tracking an object using frames from a Doppler radar system.

Vehicles may incorporate a Doppler radar system for detecting and tracking objects. The Doppler radar system uses the Doppler Effect to determine the location and radial velocity of objects. The Doppler radar system repeatedly bounces a microwave signal off a target and analyzes how the objects motion has altered the frequency of the returned signal. This variation gives direct and highly accurate measurements of the radial component of the object's velocity relative to the radar.

When used to detect objects close to the Doppler radar system, the radar system may receive many reflected data points from a respective object in each respective radar frame. The Radar system must determine how to associate these data points into a cluster (i.e., a group of data points representing an object), and how to identify a specific location designated as a centroid of each cluster. The radar system may also associate identified clusters from different radar frames, representing the same object, in order to define a track of the object over time.

### SUMMARY

A method of tracking an object is provided. The method includes establishing a track, with a computing unit, from a plurality of sequential Doppler radar frames f−1, f−2, f−3, etc. The computing unit identifies a location of a representative centroid of a cluster of data points is identified in a Doppler radar frame f. The computing unit calculates a radial velocity between a location of the track in the Doppler radar frame f−1 and the location of the representative centroid of the cluster in the Doppler radar frame f. The computing unit then calculates an error between a Doppler velocity of the track in the Doppler radar frame f−1 and the calculated radial velocity. The computing unit compares the calculated error to a minimum error threshold, to determine if the calculated error is equal to or greater than the minimum error threshold, of if the calculated error is less than the minimum error threshold. The computing unit associates the representative centroid of the cluster in the Doppler radar frame f with the track when the calculated error is less than the minimum error threshold.

In one aspect of the method of tracking the object, establishing the track from the plurality of sequential Doppler radar frames f−1, f−2, f−3, etc., includes identifying a location of the track in each of the respective Doppler radar frames f−1, f−2, f−3, etc. The location of the track in each respective Doppler radar frame includes Cartesian coordinates and a Doppler velocity.

In one aspect of the method of tracking the object, identifying the location of the representative centroid of the cluster includes identifying Cartesian coordinates and a Doppler velocity for the representative centroid.

In one aspect of the method of tracking the object, calculating the radial velocity includes calculating an X-axis velocity, a Y-axis velocity, and a Z-axis velocity. The X-axis velocity is calculated from the equation:

$$\dot{x} = \frac{( {x}_{c} - {x}_{t} )}{Δ T} .$$

The Y-axis velocity is calculated from the equation:

$$\dot{y} = \frac{( {y}_{c} - {y}_{t} )}{Δ T} .$$

The Z-axis velocity is calculated from the equation:

$$\dot{z} = \frac{( {z}_{c} - {z}_{t} )}{Δ T} .$$

Within the above equations for the X-axis velocity, the Y-axis velocity, and the Z-axis velocity, \dot{x} is the X-axis velocity, x_{c} is the X-axis coordinate of the representative centroid in the Doppler radar frame f, xₜ is the X-axis coordinate of the track in the Doppler radar frame f−1, \dot{y} is the Y-axis velocity, y_{c} is the Y-axis coordinate of the representative centroid in the Doppler radar frame f, yₜ is the Y-axis coordinate of the track in the Doppler radar frame f−1, ż is the Z-axis velocity, z_{c} is the Z-axis coordinate of the representative centroid in the Doppler radar frame f, and zₜ is the Z-axis coordinate of the track in the Doppler radar frame f−1.

The radial velocity may then be calculated from the equation:

$$\hat{v} = \frac{{x}_{t} \dot{x} + {y}_{t} \dot{y} + {z}_{t} \dot{z}}{\sqrt{{x}_{t}^{2} + {y}_{t}^{2} + {z}_{t}^{2}}} ,$$

wherein \hat{v} is the radial velocity, \dot{x} is the X-axis velocity, \dot{y} is the Y-axis velocity, ż is the Z-axis velocity, x_{c} is the X-axis coordinate of the representative centroid in the Doppler radar frame f, y_{c} is the Y-axis coordinate of the representative centroid in the Doppler radar frame f, z_{c} is the Z-axis coordinate of the representative centroid in the Doppler radar frame f, xₜ is the X-axis coordinate of the track in the Doppler radar frame f−1, yₜ is the Y-axis coordinate of the track in the Doppler radar frame f−1, and zₜ is the Z-axis coordinate of the track in the Doppler radar frame f−1.

In one aspect of the method of tracking the object, calculating the error includes calculating the error from the equation: ε_{tc}=∥dₜ−\hat{v}∥ wherein ε_{tc} is the error between the Doppler velocity of the track in the Doppler radar frame f−1 and the calculated radial velocity, dₜ is the Doppler velocity of the track in the Doppler radar frame f−1, and dₜ is the calculated radial velocity.

In one embodiment of the method of tracking the object, identifying the location of the representative centroid of the cluster in the Doppler radar frame f includes calculating a respective density for each data point in the Doppler radar frame f. The respective density for each data point in the Doppler radar frame f may be calculated from the equation:

$${ρ}_{i} = \frac{n}{{V}_{i}} ,$$

wherein ρᵢ is the density of data point i, n is the total number of data points in a pre-defined region surrounding data point i, and Vᵢ is the dispersion of data point i relative to the other data points in Doppler radar frame f. The dispersion of data point i may be calculated from the equation:

$${V}_{i} = \frac{{\sum }_{j = 1}^{n} ‖ {d}_{i} - {d}_{j} ‖}{n} ,$$

wherein Vᵢ is the dispersion of data point i, n is the total number of data points in a pre-defined region surrounding data point i, and ∥dᵢ−dⱼ∥ is the distance between data point i and data point j.

In one embodiment of the method of tracking the object, identifying the location of the representative centroid of the cluster in the Doppler radar frame f includes generating a list of data points in the Doppler radar frame f and their respective density.

A number (n) of data points in a pre-defined region surrounding data point i is compared to a minimum point threshold to determine if the number (n) of data points in the pre-defined region surrounding data point i is equal to or greater than the minimum point threshold, or if the number of data points in the pre-defined region surrounding data point i is less than the minimum point threshold. When the number of data points in the pre-defined region surrounding data point i is less than the minimum point threshold the data point i is removed from the list of data points.

In one aspect of the method of tracking the object, identifying the location of the representative centroid of the cluster in the Doppler radar frame f includes defining the data point, in the list of data points, having the highest density as the representative centroid of a cluster. The data points in the list of data points located within a pre-defined region surrounding the representative centroid are defined as the cluster of data points.

A method of identifying a cluster of data points and a representative centroid of the cluster of data points is also provided. The method is used to identify the cluster of data points and the representative centroid in a frame from a Doppler radar system having a plurality of data points. The method includes calculating a respective density for each data point in the Doppler radar frame with a computing unit. The computing unit generates a list of the data points. The list includes each data point and their respective density from the Doppler radar frame. The computing unit defines the data point, in the list of data points, having the highest density as the representative centroid. The computing unit defines the data points in the list of data points located within a pre-defined region surrounding the representative centroid as the cluster of data points.

In one aspect of the method, the computing unit compares a number (n) of data points in the pre-defined region surrounding a data point i to a minimum point threshold to determine if the number (n) of data points in the pre-defined region surrounding the data point i is equal to or greater than the minimum point threshold, or if the number of data points in the pre-defined region surrounding the data point i is less than the minimum point threshold. When the number (n) of data points in the pre-defined region surrounding data point i is less than the minimum point threshold, the computing unit removes the data point i from the list of data points.

In one aspect of the method, the computing unit calculates the respective density for each data point in the Doppler radar frame from the equation:

$${ρ}_{i} = \frac{n}{{V}_{i}} ,$$

wherein ρᵢ is the density of data point i, n is the total number of data points in a pre-defined region surrounding data point i, and Vᵢ is the dispersion of data point i relative to the other data points in the Doppler radar frame. The computing unit calculates the dispersion of data point i from the equation:

$${V}_{i} = \frac{{\sum }_{j = 1}^{n} ‖ {d}_{i} - {d}_{j} ‖}{n} ,$$

wherein Vᵢ is the dispersion of data point i, n is the total number of data points in a pre-defined region surrounding data point i, and ∥dᵢ−dⱼ∥ is the distance between data point i and data point j.

Accordingly, the process of identifying a cluster of data points and a representative centroid of the cluster of data points, and the process of tracking the cluster over multiple radar frames, provide a more accurate data association techniques, which provides a more robust tracking and representation of detected objects. The methods described herein improve the operation of the computing unit by making the identification of the cluster and representative centroid, as well as tracking of the clusters, faster and requiring less processing time.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a vehicle sensing an object with a Doppler radar system.

FIG. 2 is a schematic plan view of a Doppler radar frame showing a plurality of data points representing a first cluster, a second cluster and a third cluster, and also showing a first track and a second track.

FIG. 3 is a chart showing a calculated error for each combination of the first track and the second track, shown in respective rows, and the first cluster, the second cluster, and the third cluster, shown in respective columns.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

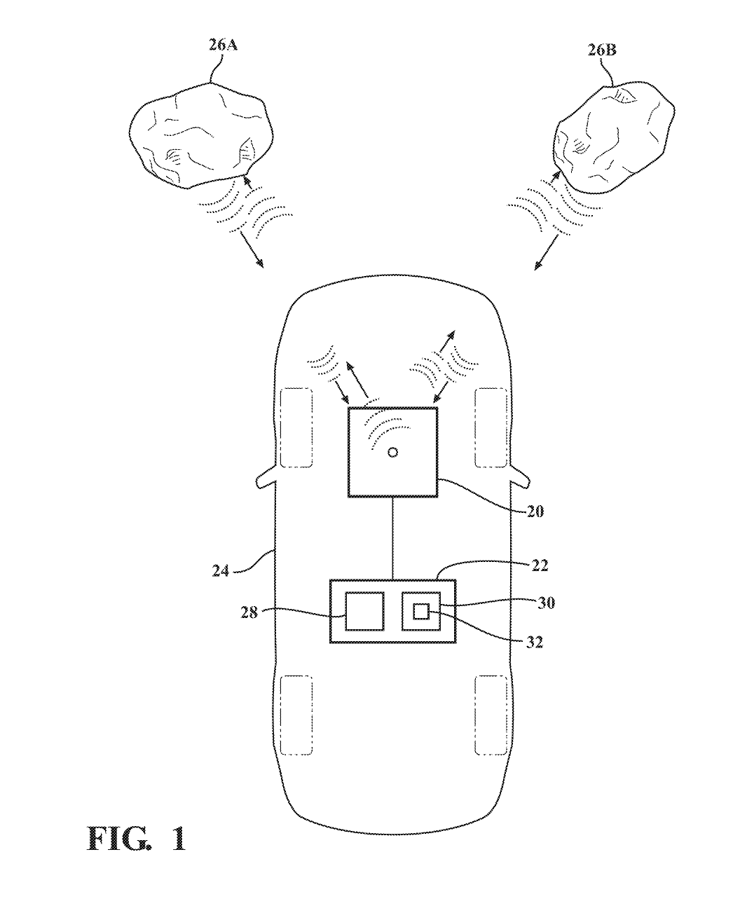

Referring to the FIGS., wherein like numerals indicate like parts throughout the several views, a method of tracking an object 26A, 26B with a Doppler radar system 20 is described. Referring to FIG. 1, the method may be implemented on a computing unit 22 in communication with the Doppler radar system 20. The computing unit 22 may be integrated into a vehicle 24. The vehicle 24 may include any moveable platform, including but not limited to, a car, a truck, a plane, a boat, an ATV, etc. Alternatively, the computing unit 22 may be stationary.

As appreciated by those skilled in the art, the Doppler radar system 20 uses the Doppler Effect to determine the location and radial velocity of objects 26A, 26B. The Doppler radar system 20 repeatedly bounces a microwave signal off a target and analyzes how the objects 26A, 26B motion alters the frequency of the returned signal. This variation gives direct and highly accurate measurements of the radial component of the object's 26A, 26B velocity relative to the radar. Each cycle of the Doppler radar system 20 generates a Doppler radar frame, which includes a plurality of data points, each representing a returned or reflected microwave signal. The Doppler radar system 20 operates repeatedly to generate sequential Doppler radar frames over a period of time. The specific features and operation of the Doppler radar system 20 are understood by those skilled in the art, are not pertinent to the teachings of this disclosure, and are therefore not described in detail herein.

The computing unit 22 may be referred to as a control module, a controller, a computer, etc. The computing unit 22 may include a computer and/or processor 28, and include all software, hardware, memory, algorithms, connections, sensors, etc., necessary to implement the method of tracking an object. As such, the method may be embodied as a program or algorithm operable on the computing unit 22. It should be appreciated that the computing unit 22 may include a device capable of analyzing data from the Doppler radar system 20 and/or various sensors, comparing data, and making the necessary decisions required to identify and track an object.

The computing unit 22 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The computing unit 22 includes tangible, non-transitory memory 30 on which are recorded computer-executable instructions, including an object tracking algorithm 32. The processor 28 of the computing unit 22 is configured for executing the object tracking algorithm 32. The object tracking algorithm 32 implements the method of tracking the object using the Doppler radar frames generated by the Doppler radar system 20.

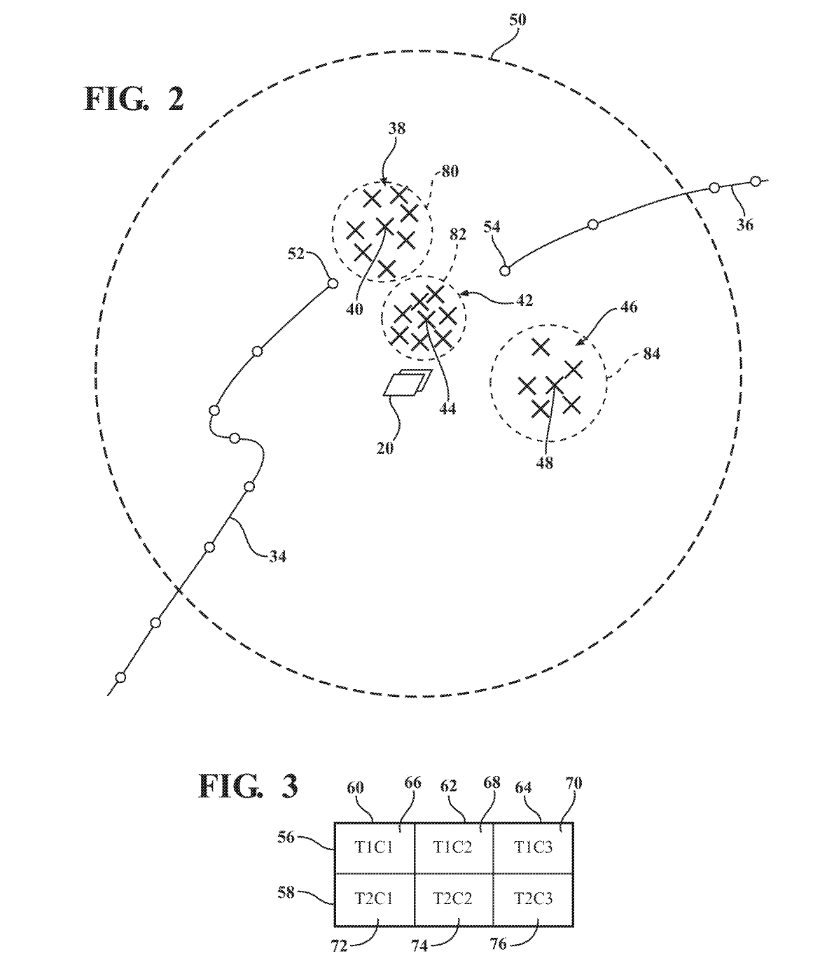

Referring to FIG. 2, the method includes establishing one or more tracks from a plurality of sequential Doppler radar frames f−1, f−2, f−3, etc. FIG. 2 shows a first track 34 of object 26A (shown in FIG. 1), and a second track 36 of object 26B (shown in FIG. 1). As noted above, each radar frame includes a plurality of data points. The data points of individual radar frames are analyzed to group the data points of a respective radar frame into one or more clusters of data points, with each cluster representing a respective object 26A, 26B. It should be appreciated that each individual radar frame may include several different clusters, with each cluster representing a different object. The clusters from sequential radar frames may then be analyzed to associate the clusters representing the same object 26A, 26B in the different radar frames together, thereby defining a track of that object 26A, 26B. In other words, a cluster representing a specific object 26A, 26B in each radar frame is associated with a cluster in the next sequential radar frame representing that same object 26A, 26B to establish a track of that object 26A, 26B over time. It should be appreciated that the computing unit 22 may establish and follow several tracks simultaneously.

Each track includes a respective location and a Doppler velocity from each radar frame f−1, f−2, f−3, etc. As used herein, radar frame f is a current radar frame and is shown in FIG. 2 at 50, radar frame f−1 is the radar frame obtained immediately prior to radar frame f, radar frame f−2 is the radar frame obtained immediately prior to radar frame f−1, etc. The location of the track in each respective radar frame includes Cartesian coordinates and a Doppler velocity. The Cartesian coordinates include and X-axis location, a Y-axis location, and a Z-axis location. The Doppler velocity is the radial velocity of the track in the respective radar frame relative to the Doppler radar system 20.

The tracks are established from radar frames f−1, f−2, f−3, etc. Upon the Doppler radar system 20 generating the current radar frame f, the computing unit 22 proceeds to analyze the radar frame f in order to identify the clusters in the radar frame f, and then analyze the radar frame f to determine if any of the clusters should be associated with any of the tracks. The computing unit 22 may also identify a location of a representative centroid of a cluster of data points in the radar frame f. FIG. 2 shows a first cluster 38 having a first representative centroid 40, a second cluster 42 having a second representative centroid 44, and a third cluster 46 having a third representative centroid 48.

Identifying the location of the representative centroid of a cluster includes identifying the Cartesian coordinates and the Doppler velocity for the representative centroid. The representative centroid is one of the data points that is defined as the centroid of a specific cluster. As such, the computing unit 22 uses the Cartesian coordinates and the Doppler velocity of the data point defined as the representative centroid, as the Cartesian coordinates and the Doppler velocity of the cluster to which the representative centroid is part of.

Identifying the location of the representative centroid of a cluster in the Doppler radar frame f includes calculating a respective density for each data point in the Doppler radar frame f. Referring to FIG. 1, radar frame f is generally shown at 50 in FIG. 2. Each data point of radar frame f is represented by an “x” in FIG. 2. The respective density for each data point in the radar frame f may be calculated from Equation 1 below.

$${ρ}_{i} = \frac{n}{{V}_{i}} \qquad 1 )$$

Referring to Equation 1: ρ_{A} is the density of data point i, n is the total number of data points in a pre-defined region surrounding data point i, and Vᵢ is the dispersion of data point i relative to the other data points in Doppler radar frame f. The pre-defined region may be defined to include any radial distance suitable for the intended application of the process. It should be appreciated that data point i may represent any one of the data points shown in radar frame f.

The dispersion of data point i may be calculated from Equation 2 below.

$${V}_{i} = \frac{{\sum }_{j = 1}^{n} ‖ {d}_{i} - {d}_{j} ‖}{n} \qquad 2 )$$

Referring to Equation 2: Vᵢ is the dispersion of data point i, n is the total number of data points in a pre-defined region surrounding data point i, and ∥dᵢ−dⱼ∥ is the distance between data point i and data point j. It should be appreciated that data point j may be any one of the data points in radar frame f other than data point i.

Once the computing unit 22 has calculated the density for each data point in the radar frame f then the computing unit 22 generates a list of the data points in the Doppler radar frame f and their respective density. The list of data points includes each data point, and its respective density. The list may be arranged in any desired configuration.

The computing unit 22 then compares the number (n) of data points in the pre-defined region surrounding each data point (e.g., data point i) to a minimum point threshold to determine if the number (n) of data points in the pre-defined region surrounding each respective data point is equal to or greater than the minimum point threshold, or if the number of data points in the pre-defined region surrounding each respective data point is less than the minimum point threshold. The computing unit 22 may then remove any data point from the list of data points in which the number (n) of data points in the pre-defined region surrounding each respective data point is less than the minimum point threshold. Larger values for the pre-defined region will result in fewer data points being removed, whereas smaller values for the pre-defined region will result in more clusters being removed. For example, the computing unit 22 compares the number (n) of data points in the pre-defined region surrounding point i to the minimum point threshold. If the number (n) of data points in the pre-defined region surrounding point i is equal to or greater than the minimum point threshold, then the computing unit 22 keeps point i in the list of data points. However, if the number (n) of points in the pre-defined region surrounding point i is less than the minimum point threshold, then the computing unit 22 removes point i from the list of data points. In so doing, the computing unit 22 removes noise and/or outlying data points that may not be related to any specific object in radar frame f.

Once the computing unit 22 has removed the outlying data points from the list of data points, the computing unit 22 may then define the data point having the highest density, in the list of data points, as the representative centroid of a cluster. Accordingly, considering all of the data points left remaining in the list of data points after the outlying data points have been removed, the one data point having the highest density is defined as the first representative centroid 40 of the first cluster 38. The computing unit 22 then defines all of the data points in the list of data points that are located within the pre-defined region 80 surrounding the first representative centroid 40 of the first cluster 38 as the data points of the first cluster 38. Larger values for the pre-defined region will result in fewer clusters being identified, whereas smaller values for the pre-defined region will result in more clusters being identified.

The computing unit 22 then removes the data points of the first cluster 38, including the data point defined as the first representative centroid 40 of the first cluster 38, from the list of data points to define a revised list of data points. The computing unit 22 then defines the data point having the highest density, in the revised list of data points as the second representative centroid 44 of the second cluster 42, and defines all of the data points in the revised list of data points that are located within the pre-defined region 82 surrounding the second representative centroid 44 of the second cluster 42 as the data points of the second cluster 42.

The computing unit 22 then removes the data points of the second cluster 42, including the data point defined as the second representative centroid 44 of the second cluster 42, from the revised list of data points to define a second revised list of data points. The computing unit 22 then defines the data point having the highest density, in the second revised list of data points as the third representative centroid 48 of the third cluster 46, and defines all of the data points in the second revised list of data points that are located within the pre-defined region 84 surrounding the third representative centroid 48 of the third cluster 46 as the data points of the third cluster 46. This process is repeated until all of the data points have been assigned to a respective cluster.

The clusters and their respective representative centroid from radar frame f are identified as described above. The representative centroid for each cluster is used to define the location of that cluster in radar frame f. As such, the location of the first representative centroid 40 of the first cluster 38 is defined as the location of the first cluster 38. Similarly, the location of the second representative centroid 44 of the second cluster 42 is defined as the location of the second cluster 42, and the location of the third representative centroid 48 of the third cluster 46 is defined as the location of the third cluster 46. As noted above, the location of each cluster, i.e., the representative centroid of each cluster, includes Cartesian coordinates (a X-axis location, a Y-axis location, and a Z-axis location) and a Doppler velocity.

Once the computing unit 22 has identified the clusters of radar frame f and their locations, i.e., the location of their representative centroid, the computing unit 22 then calculates a radial velocity between a location of each established track in the Doppler radar frame f−1 and the location of the representative centroid of each cluster in the Doppler radar frame f. For example, FIG. 1 shows the first track 34 and the second track 36, as well as the first cluster 38, the second cluster 42, and the third cluster 46. The computing unit 22 calculates the radial velocity between the first track 34 and the first cluster 38, between the first track 34 and the second cluster 42, and between the first track 34 and the third cluster 46. Similarly, the computing unit 22 calculates the radial velocity between the second track 36 and the first cluster 38, between the second track 36 and the second cluster 42, and between the second track 36 and the third cluster 46.

The radial velocity for each track/cluster combination may be calculated by first calculating an X-axis velocity, a Y-axis velocity, and a Z-axis velocity, and then using these values to calculate the radial velocity between the respective track and the respective cluster. The X-axis velocity may be calculated from Equation 3 below, the Y-axis velocity may be calculated from Equation 4 below, and the Z-axis velocity may be calculated from Equation 5 below.

$$\begin{matrix}\dot{x} = \frac{( {x}_{c} - {x}_{t} )}{Δ T} & 3 ) \\ \dot{y} = \frac{( {y}_{c} - {y}_{t} )}{Δ T} & 4 ) \\ \dot{z} = \frac{( {z}_{c} - {z}_{t} )}{Δ T} & 5 )\end{matrix}$$

Referring to Equations 3, 4, and 5: \dot{x} is the X-axis velocity, x_{c} is the X-axis coordinate of the representative centroid in the Doppler radar frame f, xₜ is the X-axis coordinate of the track in the Doppler radar frame f−1, 5; is the Y-axis velocity, y_{c} is the Y-axis coordinate of the representative centroid in the Doppler radar frame f, yₜ is the Y-axis coordinate of the track in the Doppler radar frame f−1, ż is the Z-axis velocity, z_{c} is the Z-axis coordinate of the representative centroid in the Doppler radar frame f, and zₜ is the Z-axis coordinate of the track in the Doppler radar frame f−1.

The computing unit 22 may calculate the radial velocity from the Equation 6 below.

$$\hat{v} = \frac{{x}_{t} \dot{x} + {y}_{t} \dot{y} + {z}_{t} \dot{z}}{\sqrt{{x}_{t}^{2} + {y}_{t}^{2} + {z}_{t}^{2}}} \qquad 6 )$$

Referring to Equation 6: \hat{v} is the radial velocity, \dot{x} is the X-axis velocity, \dot{y} is the Y-axis velocity, ż is the Z-axis velocity, x_{c} is the X-axis coordinate of the representative centroid in the Doppler radar frame f, y_{c} is the Y-axis coordinate of the representative centroid in the Doppler radar frame f, z_{c} is the Z-axis coordinate of the representative centroid in the Doppler radar frame f, xₜ is the X-axis coordinate of the track in the Doppler radar frame f−1, yₜ is the Y-axis coordinate of the track in the Doppler radar frame f−1, and zₜ is the Z-axis coordinate of the track in the Doppler radar frame f−1.

Once the computing unit 22 has calculated the radial velocity for each track/cluster combination in the radar frame f, the computing unit 22 calculates an error between a Doppler velocity of a track in the Doppler radar frame f−1 and the calculated radial velocity of a respective track/cluster combination from radar frame f. The location of the first track 34 from radar frame f−1 is generally indicated by point 52 of the first track 34. The location of the second track 36 from radar frame f−1 is generally indicated by point 54 of the second track 36. This error is calculated for each possible combination of established tracks and calculated Doppler velocities. For example, referring to FIG. 1, the computing unit 22 calculates a respective error value between the Doppler velocity of the first track 34 from radar frame f−1 and the calculated radial velocity for each combination of the first track 34 and the first cluster 38, the second cluster 42, and the third cluster 46. Similarly, the computing unit 22 calculates a respective error value between the Doppler velocity of the second track 36 from radar frame f−1 and the calculated radial velocity for each combination of the second track 36 and the first cluster 38, the second cluster 42, and the third cluster 46.

The computing unit 22 may calculate the error from the Equation 7 below.

ε_{tc}=∥dₜ−\hat{v}∥

Referring to Equation 7: ε_{tc} is the error between the Doppler velocity of the track in the Doppler radar frame f−1 and the calculated radial velocity, dₜ is the Doppler velocity of the track in the Doppler radar frame f−1, and \hat{v} is the calculated radial velocity.

The computing unit 22 may store and/or arrange the calculated errors for each combination in a suitable manner. For example, referring to FIG. 3, the calculated error values for the different combinations are arranged in a chart. Referring to FIG. 3, the first track 34 is disposed in a first row 56, and the second track 36 is disposed in a second row 58. The first cluster 38 is disposed in a first column 60, the second cluster 42 is disposed in a second column 62, and the third cluster 46 is disposed in a third column 64. The calculated error between the first track 34 and the first cluster 38 is positioned in a first box 66, labeled T1C1. The calculated error between the first track 34 and the second cluster 42 is positioned in a second box 68 labeled T1C2. The calculated error between the first track 34 and the third cluster 46 is positioned in a third box 70 labeled T1C3. The calculated error between the second track 36 and the first cluster 38 is positioned in a fourth box 72, labeled T2C1. The calculated error between the second track 36 and the second cluster 42 is positioned in a fifth box 74 labeled T2C2. The calculated error between the second track 36 and the third cluster 46 is positioned in sixth box 76 labeled T2C3.

The computing unit 22 then compares each respective calculated error value for each possible combination to a minimum error threshold to determine if the calculated error is equal to or greater than the minimum error threshold, of if the calculated error is less than the minimum error threshold. When the computing unit 22 determines that the calculated error is less than the minimum error threshold, then the computing unit 22 associates the respective cluster and the representative centroid of the cluster in the Doppler radar frame f with the respective track. For example, the computing unit 22 may calculate the error between the first track 34 and the first cluster 38, as represented by the first box 66 labeled T1C1 in FIG. 3. If the calculated error between the first track 34 and the first cluster 38 is less than the minimum error threshold, then the computing unit 22 may determine that the first cluster 38 is the object 26A being tracked by the first track 34, and associate the first cluster 38 with the first track 34. The computing unit 22 may then define the location of the first track 34 in radar frame f by the location of the representative centroid of the first cluster 38. However, if the calculated error between the first track 34 and the first cluster 38 is equal to or greater than the minimum error threshold, then the computing unit 22 may determine that the first cluster 38 is not related to the object 26A of the first track 34, and does not associate the first cluster 38 with the first track 34.

The minimum error threshold may be defined to include a value suitable for the particular application of the process. The larger the value of the minimum error threshold, the more likely that the computing unit 22 will associate a cluster with a track, i.e., a lower tolerance, whereas a smaller value of the minimum error threshold, the more likely that the computing unit 22 will not associate a cluster with a track, i.e., a higher tolerance.

This process is repeated for each combination of track and calculated radial velocity, as represented in FIG. 3. For example, the computing unit 22 may calculate the error between the second track 36 and the first cluster 38, as represented by the fourth box 72 labeled T2C1 in FIG. 3. If the calculated error between the second track 36 and the first cluster 38 is less than the minimum error threshold, then the computing unit 22 may determine that the first cluster 38 is the object 26B being tracked by the second track 36, and associates the first cluster 38 with the second track 36. The computing unit 22 may then define the location of the second track 36 in radar frame f by the location of the representative centroid of the first cluster 38. However, if the calculated error between the second track 36 and the first cluster 38 is equal to or greater than the minimum error threshold, then the computing unit 22 may determine that the first cluster 38 is not related to the object 26B of the second track 36, and does not associate the first cluster 38 with the second track 36.

Once the computing unit 22 has analyzed the clusters to determine if they are associated with any of the tracks, as described above, then the process is repeated for the next radar frame f+1, f+2, f+3, etc. The tracks and their respective locations may be communicated to a controller for use. For example, the tracks and their respective locations may be communicated to a contact avoidance controller, which may operate a vehicle 24 system, such as a brake system, to avoid contact with the object 26A, 26B of the track.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of tracking an object, the method comprising:
establishing a track, with a computing unit, from a plurality of sequential Doppler radar frames f−1, f−2, f−3, etc.;
identifying a location of a representative centroid of a cluster of data points in a Doppler radar frame f, with the computing unit;
calculating a radial velocity, with the computing unit, between a location of the track in the Doppler radar frame f−1 and the location of the representative centroid of the cluster in the Doppler radar frame f;
calculating an error, with the computing unit, between a Doppler velocity of the track in the Doppler radar frame f−1 and the calculated radial velocity;
comparing the calculated error to a minimum error threshold, with the computing unit, to determine if the calculated error is equal to or greater than the minimum error threshold, or if the calculated error is less than the minimum error threshold; and
associating the representative centroid of the cluster in the Doppler radar frame f with the track, with the computing unit, when the calculated error is less than the minimum error threshold.

2. The method set forth in claim 1, wherein identifying the location of the representative centroid of the cluster includes identifying Cartesian coordinates and a Doppler velocity for the representative centroid.

3. The method set forth in claim 1, wherein establishing the track from the plurality of sequential Doppler radar frames f−1, f−2, f−3, etc., includes identifying a location of the track in each of the respective Doppler radar frames f−1, f−2, f−3, etc., wherein the location of the track in each respective Doppler radar frame includes Cartesian coordinates and a Doppler velocity.

4. The method set forth in claim 1, wherein calculating the radial velocity includes calculating an X-axis velocity, a Y-axis velocity, and a Z-axis velocity.

5. The method set forth in claim 4, wherein:
the X-axis velocity is calculated from the equation:
$$\dot{x} = \frac{( {x}_{c} - {x}_{t} )}{Δ T} ;$$
the Y-axis velocity is calculated from the equation:
$$\dot{y} = \frac{( {y}_{c} - {y}_{t} )}{Δ T} ;$$
the Z-axis velocity is calculated from the equation:
$$\dot{z} = \frac{( {z}_{c} - {z}_{t} )}{Δ T} ;$$
wherein \dot{x} is the X-axis velocity, x_{c} is the X-axis coordinate of the representative centroid in the Doppler radar frame f, xₜ is the X-axis coordinate of the track in the Doppler radar frame f−1, \dot{y} is the Y-axis velocity, y_{c} is the Y-axis coordinate of the representative centroid in the Doppler radar frame f, yₜ is the Y-axis coordinate of the track in the Doppler radar frame f−1, ż is the Z-axis velocity, z_{c} is the Z-axis coordinate of the representative centroid in the Doppler radar frame f, and zₜ is the Z-axis coordinate of the track in the Doppler radar frame f−1.

6. The method set forth in claim 4, wherein calculating the radial velocity includes calculating the radial velocity from the equation:
$$\hat{v} = \frac{{x}_{t} \dot{x} + {y}_{t} \dot{y} + {z}_{t} \dot{z}}{\sqrt{{x}_{t}^{2} + {y}_{t}^{2} + {z}_{t}^{2}}}$$
wherein \hat{v} is the radial velocity, \dot{x} is the X-axis velocity, \dot{y} is the Y-axis velocity, ż is the Z-axis velocity, x_{c} is the X-axis coordinate of the representative centroid in the Doppler radar frame f, y_{c} is the Y-axis coordinate of the representative centroid in the Doppler radar frame f, z_{c} is the Z-axis coordinate of the representative centroid in the Doppler radar frame f, xₜ is the X-axis coordinate of the track in the Doppler radar frame f−1, yₜ is the Y-axis coordinate of the track in the Doppler radar frame f−1, and zₜ is the Z-axis coordinate of the track in the Doppler radar frame f−1.

7. The method set forth in claim 1, wherein calculating the error includes calculating the error from the equation:
ε_{tc}=∥dₜ−\hat{v}∥
wherein ε_{tc} is the error between the Doppler velocity of the track in the Doppler radar frame f−1 and the calculated radial velocity, dₜ is the Doppler velocity of the track in the Doppler radar frame f−1, and \hat{v} is the calculated radial velocity.

8. The method set forth in claim 1, wherein identifying the location of the representative centroid of the cluster in the Doppler radar frame f includes calculating a respective density for each data point in the Doppler radar frame f.

9. The method set forth in claim 8, wherein calculating the respective density for each data point in the Doppler radar frame f includes calculating the density for each respective data point from the equation:
$${ρ}_{i} = \frac{n}{{V}_{i}}$$
wherein ρₜ is the density of data point i, n is the total number of data points in a pre-defined region surrounding data point i, and Vᵢ is the dispersion of data point i relative to the other data points in Doppler radar frame f.

10. The method set forth in claim 9, wherein the dispersion of data point i is calculated from the equation:
$${V}_{i} = \frac{{\sum }_{j = 1}^{n} ‖ {d}_{i} - {d}_{j} ‖}{n}$$
wherein Vᵢ is the dispersion of data point i, n is the total number of data points in a pre-defined region surrounding data point i, and ∥dᵢ−dⱼ∥ is the distance between data point i and data point j.

11. The method set forth in claim 8, wherein identifying the location of the representative centroid of the cluster in the Doppler radar frame f includes generating a list of data points in the Doppler radar frame f and their respective density.

12. The method set forth in claim 11, wherein identifying the location of the representative centroid of the cluster in the Doppler radar frame f includes comparing a number (n) of data points in a pre-defined region surrounding data point i to a minimum point threshold to determine if the number (n) of data points in the pre-defined region surrounding data point i is equal to or greater than the minimum point threshold, or if the number of data points in the pre-defined region surrounding data point i is less than the minimum point threshold.

13. The method set forth in claim 12, wherein identifying the location of the representative centroid of the cluster in the Doppler radar frame f includes removing data point i from the list of data points when the number of data points in the pre-defined region surrounding data point i is less than the minimum point threshold.

14. The method set forth in claim 11, wherein identifying the location of the representative centroid of the cluster in the Doppler radar frame f includes defining the data point, in the list of data points, having the highest density as the representative centroid.

15. The method set forth in claim 14, wherein identifying the location of the representative centroid of the cluster in the Doppler radar frame f includes defining the data points in the list of data points located within a pre-defined region surrounding the representative centroid as the cluster of data points.

16. A method of identifying a cluster of data points and a representative centroid of the cluster of data points in a frame from a Doppler radar having a plurality of data points, the method comprising:
calculating a respective density for each data point in the Doppler radar frame;
generating a list of the data points and their respective density from the Doppler radar frame;
defining the data point, in the list of data points, having the highest density as the representative centroid; and
defining the data points in the list of data points located within a pre-defined region surrounding the representative centroid as the cluster of data points.

17. The method set forth in claim 16, further comprising comparing a number (n) of data points in a pre-defined region surrounding a data point i to a minimum point threshold to determine if the number (n) of data points in the pre-defined region surrounding the data point i is equal to or greater than the minimum point threshold, or if the number of data points in the pre-defined region surrounding the data point i is less than the minimum point threshold.

18. The method set forth in claim 17, further comprising removing the data point i from the list of data points when the number (n) of data points in the pre-defined region surrounding data point i is less than the minimum point threshold.

19. The method set forth in claim 16, wherein calculating the respective density for each data point in the Doppler radar frame includes calculating the density for each respective data point from the equation:
$${ρ}_{i} = \frac{n}{{V}_{i}}$$
wherein ρᵢ is the density of data point i, n is the total number of data points in a pre-defined region surrounding data point i, and Vᵢ is the dispersion of data point i relative to the other data points in the Doppler radar frame.

20. The method set forth in claim 9, wherein the dispersion of data point i is calculated from the equation:
$${V}_{i} = \frac{{\sum }_{j = 1}^{n} ‖ {d}_{i} - {d}_{j} ‖}{n}$$
wherein Vᵢ is the dispersion of data point i, n is the total number of data points in a pre-defined region surrounding data point i, and ∥dᵢ−dⱼ∥ is the distance between data point i and data point j.
